(19) United States
(12) Patent Application Publication
(10) Pub. No.: US 2019/0259000 A1
(43) Pub. Date: Aug. 22, 2019

(54) ENHANCED CARGO DELIVERY SYSTEM

(71) Applicant: Ford Motor Company, Dearborn, MI (US)

(72) Inventor: Brandon Ryan BUCKHALT, Belleville, MI (US)

(21) Appl. No.: 16/332,889

(22) PCT Filed: Sep. 16, 2016
(86) PCT No.: PCT/US16/52028

§ 371 Date: Mar. 13, 2019

(51) Int. Cl. G06Q 10/08; G07C 9/00

(52) U.S. Cl. CPC G06Q 10/08355; G06Q 10/0838; G06Q 10/0833; G05D 1/0212; G07C 9/00817; G07C 2009/0092; G07C 9/00896

(57) ABSTRACT

A delivery route to a pickup location to collect cargo and to a delivery location to deliver the cargo is received. The delivery route includes a first location where a carrier route meets the delivery route and a second location where the carrier route diverges from the delivery route. A carrier approaching the first location is identified. A securing apparatus is actuated to engage a port disposed on the carrier when the carrier reaches the first location. The securing apparatus is disengaged from the port when the carrier reaches the second location. A propulsion is controlled to move subsystems a cargo container to the pickup location.

### BACKGROUND

Passenger vehicles, including mass transit vehicles, can transport passengers to locations throughout a city. The passenger vehicles are typically dedicated solely to transporting passengers. To deliver cargo, cargo carriers typically use dedicated cargo delivery vehicles to deliver the cargo to cargo recipients. The cargo delivery vehicles follow predetermined delivery routes that may make it difficult to accommodate specific timing needs and/or locations of cargo senders and cargo recipients. Current vehicles lack integrated mechanisms for delivering cargo and transporting passengers.

### BRIEF DESCRIPTION OF THE DRAWINGS

FIG. 1 is a block diagram of an example system for delivering cargo and transporting passengers.

FIG. 2 is a perspective view of an example carrier for delivering the cargo and transporting the passengers.

FIG. 3 is a top view of the example carrier of FIG. 2.

FIG. 4 is a rear view of the example carrier of FIG. 2.

FIG. 5 is a perspective view of an example cargo container for delivering the cargo.

FIG. 6 is an example route that the cargo container travels, including attaching to a plurality of carriers.

FIG. 7 is an example process for receiving and delivering the cargo with the cargo container of FIG. 5.

FIG. 8 is an example process for moving the cargo container along the example route of FIG. 6.

### DETAILED DESCRIPTION

A carrier transports both passengers and cargo to locations throughout a city. The carrier includes a cab that houses passengers and/or cargo. A plurality of cargo containers attach to the carrier to move to a pickup location to receive cargo and to move to a delivery location to deliver cargo. By transporting both passengers and cargo, the carrier reduces the amount of dedicated delivery vehicles to deliver cargo and reduces the energy consumed by the cargo containers to deliver cargo. Furthermore, the cargo sender can request one of the cargo containers to accommodate specific timing needs and/or locations of the cargo sender and the cargo recipient.

As used herein, the term “cargo” refers to any physical object that can be transported by a transportation vehicle as disclosed herein. Cargo can include a “package,” or “packages,” i.e., items that can be sent to a recipient, e.g., a parcel, a box, etc.

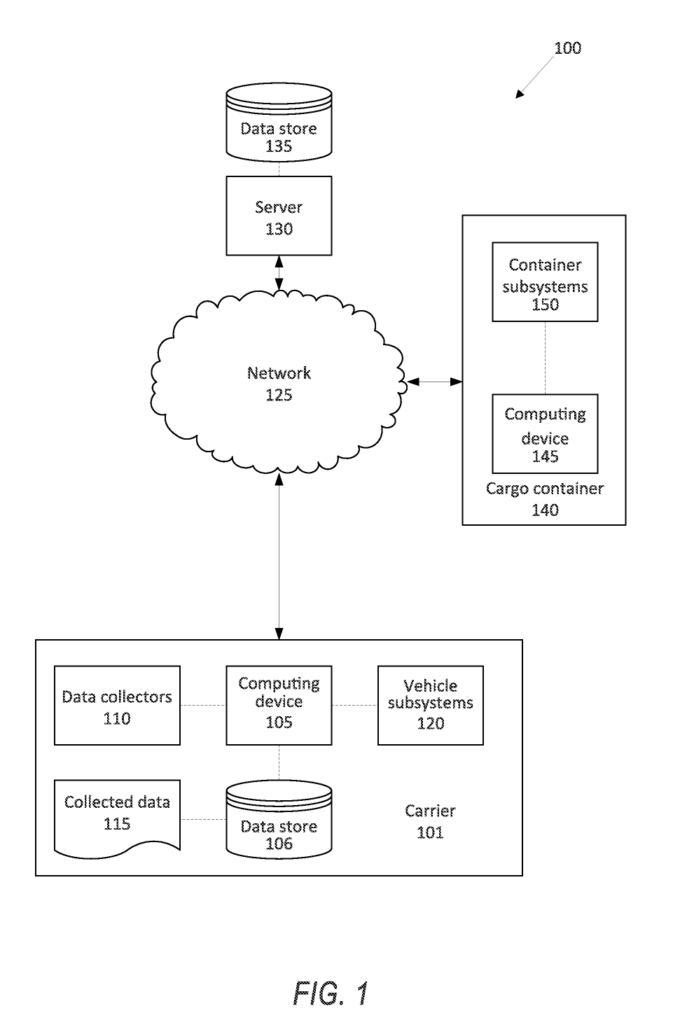

FIG. 1 illustrates a system 100 for delivering items of cargo and transporting passengers. A computing device 105 in a vehicle 101. e.g., a carrier 101. is programmed to receive collected data 115 from one or more data collectors 110. For example, vehicle 101 data 115 may include a location of the vehicle 101, a location of a target, etc. Location data may be in a known form, e.g., geo-coordinates such as latitude and longitude coordinates obtained via a navigation system that uses the Global Positioning System (GPS). Further examples of data 115 can include measurements of vehicle 101 systems and components, e.g., a vehicle 101 velocity, a vehicle 101 trajectory, etc.

The computing device 105 is generally programmed for communications on a vehicle 101 network or communications bus, as is known. Via the network, bus, and/or other wired or wireless mechanisms (e.g., a wired or wireless local area network in the vehicle 101), the computing device 105 may transmit messages to various devices in a vehicle 101 and/or receive messages from the various devices, e.g., controllers, actuators, data collectors, etc., including data collectors 110. Alternatively or additionally, in cases where the computing device 105 actually comprises multiple devices, the vehicle network or bus may be used for communications between devices represented as the computing device 105 in this disclosure. In addition, the computing device 105 may be programmed for communicating with the network 125, which, as described below, may include various wired and/or wireless networking technologies, e.g., cellular, Bluetooth®, wired and/or wireless packet networks, etc.

The data store 106 may be of a known type, e.g., hard disk drives, solid state drives, servers, or any volatile or non-volatile media. The data store 106 may store the collected data 115 sent from the data collectors 110.

Data collectors 110 may include a variety of devices. For example, as is known, various controllers in a vehicle 101 may operate as data collectors 110 to provide data 115 via the vehicle 101 network or bus, e.g., data 115 relating to vehicle speed, acceleration, position, system and/or component status, etc. Further, other data collectors 110 could include sensors such as cameras, motion detectors, short range radar, long range radar, LIDAR, and/or ultrasonic transducers, etc., i.e., data collectors 110 to provide data 115 for evaluating a location of a target, projecting a path of a parking maneuver, evaluating a location of a roadway lane, etc.

Collected data 115 may include a variety of data collected in a vehicle 101. Examples of collected data 115 are provided above, and moreover, data 115 are generally collected using one or more data collectors 110, and may additionally include data calculated therefrom in the computing device 105, and/or at the server 130. In general, collected data 115 may include any data that may be gathered by the data collectors 110 and/or computed from such data.

The vehicle 101 may include a plurality of subsystems 120. The subsystems 120 control vehicle 101 components, e.g., a vehicle seat, mirror, tiltable and/or telescoping steering wheel, etc. The subsystems 120 include, e.g., a steering subsystem, a propulsion subsystem, a brake subsystem, a park assist subsystem, an adaptive cruise control subsystem, etc. The computing device 105 may actuate the subsystems 120 to control the vehicle 101 components, e.g., to stop the vehicle 101, to avoid targets, etc. The computing device 105 may be programmed to operate some or all of the subsystems 120 with limited or no input from a human operator, i.e., the computing device 105 may be programmed to operate the subsystems 120 as a virtual operator. When the computing device 105 operates the subsystems 120 as a virtual operator, the computing device 105 does not use input from the human operator with respect to subsystems 120 selected for control by the virtual operator, which provides instructions, e.g., via a vehicle 101 communications bus and/or to electronic control units (ECUs) as are known, to actuate vehicle 101 components, e.g., to apply brakes, change a steering wheel angle, etc. For example, if the human operator attempts to turn a steering wheel during virtual operator steering operation, the computing device 105 may ignore the movement of the steering wheel and steer the vehicle 101 according to its programming.

The system 100 may further include a network 125 connected to a server 130 and a data store 135. The computer 105 may further be programmed to communicate with one or more remote sites such as the server 130, via the network 125, such remote site possibly including a data store 135. The network 125 represents one or more mechanisms by which a vehicle computer 105 may communicate with a remote server 130. Accordingly, the network 125 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, IEEE 802.11, etc.), local area networks (LAN) and/or wide area networks (WAN), including the Internet, providing data communication services.

The system 100 includes at least one cargo container 140. The cargo container 140 delivers cargo from a cargo sender to a cargo recipient. The cargo container may include a container computing device 145. The container computing device 145 includes a processor and a memory. The container computing device 145 communicates with cargo container subsystems 150 to move the cargo container 140 along a route from the cargo sender to the cargo recipient. The container computing device 145 communicates with the server 130 and the carrier computing device 105 over the network 125. The cargo container subsystems 150 may include, e.g., a propulsion, a brake, etc., and may actuate one or more cargo container components, e.g., a motor, a wheel, etc. For example, the propulsion is connected to the wheels to move the cargo container 140,

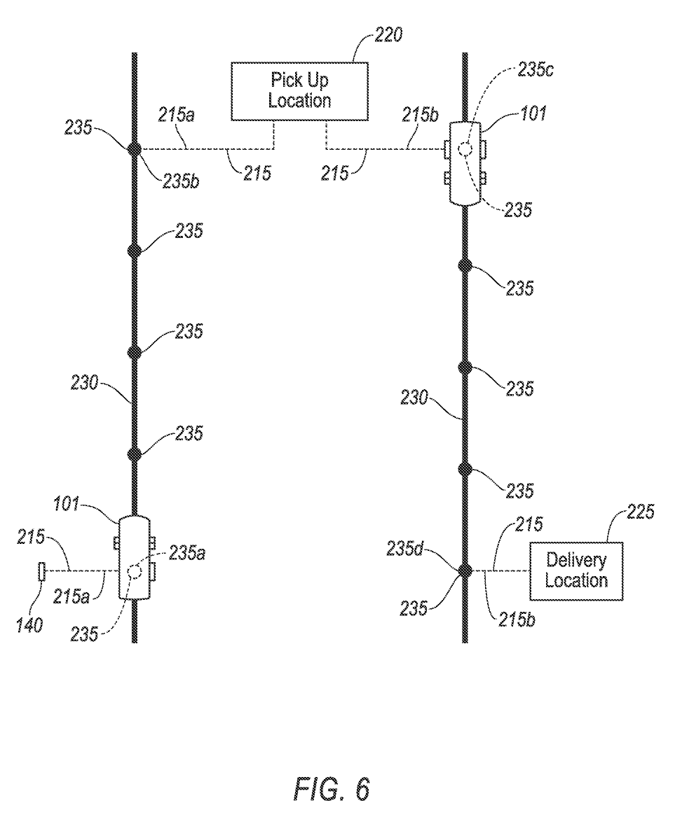

The server 130 can receive a request for one of the cargo containers 140 from a cargo sender. The cargo sender can send the request over the network 125 via, e.g., an application in a portable device, a website, etc. The request can include a size of the cargo to be delivered, a specific time to pick up the cargo, a location to pick up the cargo, and a location to deliver the cargo. Based on the request, the server 130 can locate a cargo container 140 to deliver the cargo according to the request. For example, based on the size of the cargo, the server 130 can identify a cargo container 140 that is large enough to deliver the cargo. In another example, the server 130 can identify one of the cargo containers 140 closest to the pickup location from the request, i.e., the cargo container 140 that is a shortest distance to the pickup location. In yet another example, when the cargo is larger than any one of the cargo containers 140, the server 130 can identify a carrier 101 to receive and deliver the cargo. The server 130 can receive a plurality of requests to deliver cargo, identify a respective cargo container 140 and/or carrier 101 for each request and determine a plurality of delivery routes 215 to deliver the cargo. The server can identify at least one carrier route 230, as shown in FIG. 6, that is along at least a portion of at least some of the delivery routes 215. The server 130 can control one or more of the container subsystems 150 for one or more of the cargo containers 140 to attach the cargo containers 140 assigned to the delivery routes 215 to a carrier 101 traveling along the carrier route 230.

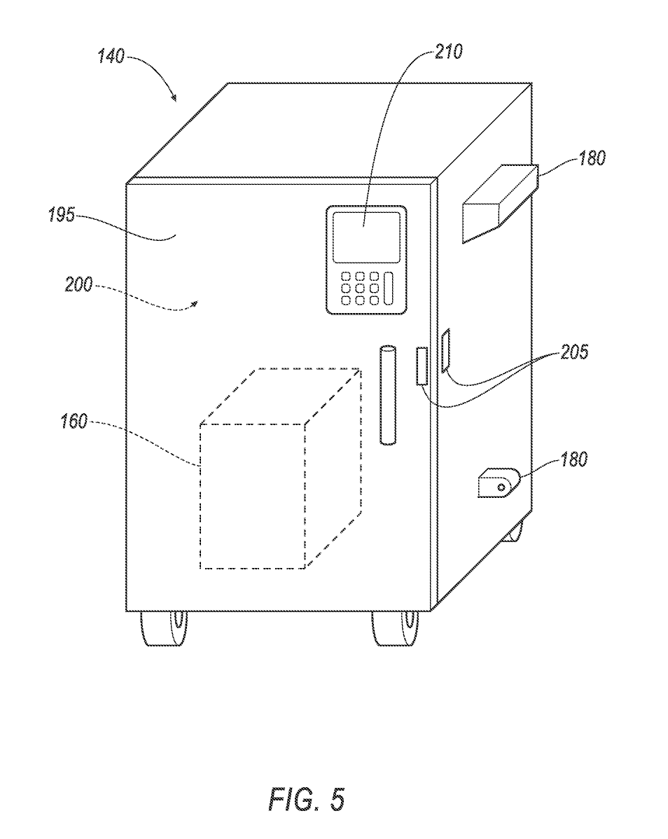

The server 130 can assign an alphanumeric code and send the code to the cargo recipient and to the container computing device 145. The cargo recipient can input the code to the container computing device 145 via an access panel 210, as shown in FIG. 5. The container computing device 115 can compare the input code from the cargo recipient to the code sent from the server 130. If the input code matches the code sent from the server 130, i.e., the input code is the same as the code sent from the server 130. the container computing device 145 can actuate a lock 205, as shown in FIG. 5, and allow the cargo recipient to receive the cargo 160. The code may be an alphanumeric code, as described above, or may be a known security measure, e.g., 2-step authenticator, a biometric scan, etc. The code can be sent via known security protocols.

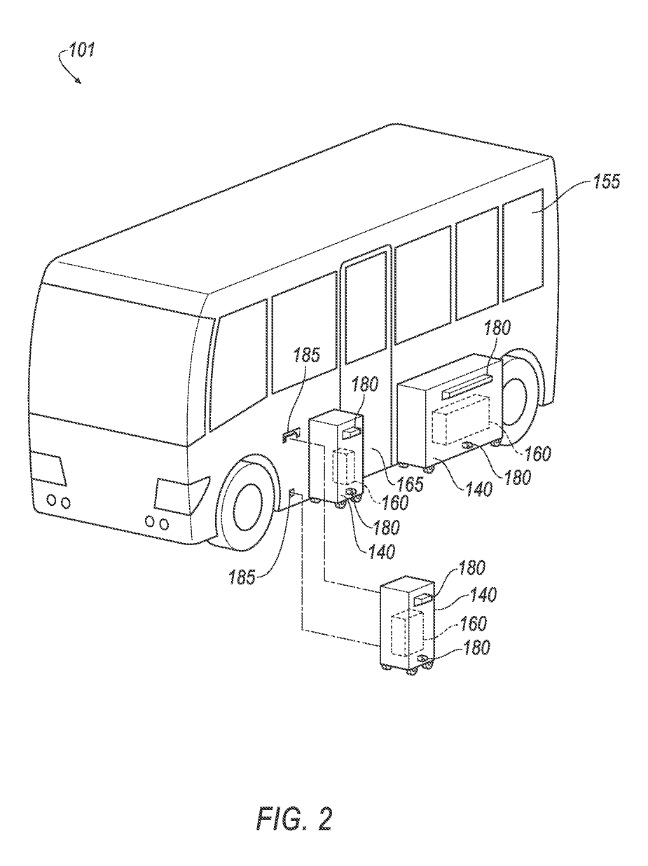

FIG. 2 illustrates an example carrier 101 with a plurality of cargo containers 140 attached to the carrier 101. The carrier 101 includes a cab 155. The cab 155 houses passengers as the carrier 101 moves along a predetermined path, e.g., a carrier route 230 as shown in FIG. 6. The cab 155 may alternatively or additionally to passengers store items of cargo 160, e.g., that cannot be accommodated by the cargo containers 140 due to being larger than a container 140, as shown in FIG. 4.

The carrier 101 includes at least one passenger door 165. The passenger door 165 allows the passengers to enter and exit the cab 155. The passenger door 165 may open when the carrier 101 reaches a carrier stop, as shown in FIG. 6, to allow passengers to enter and exit the cab 155.

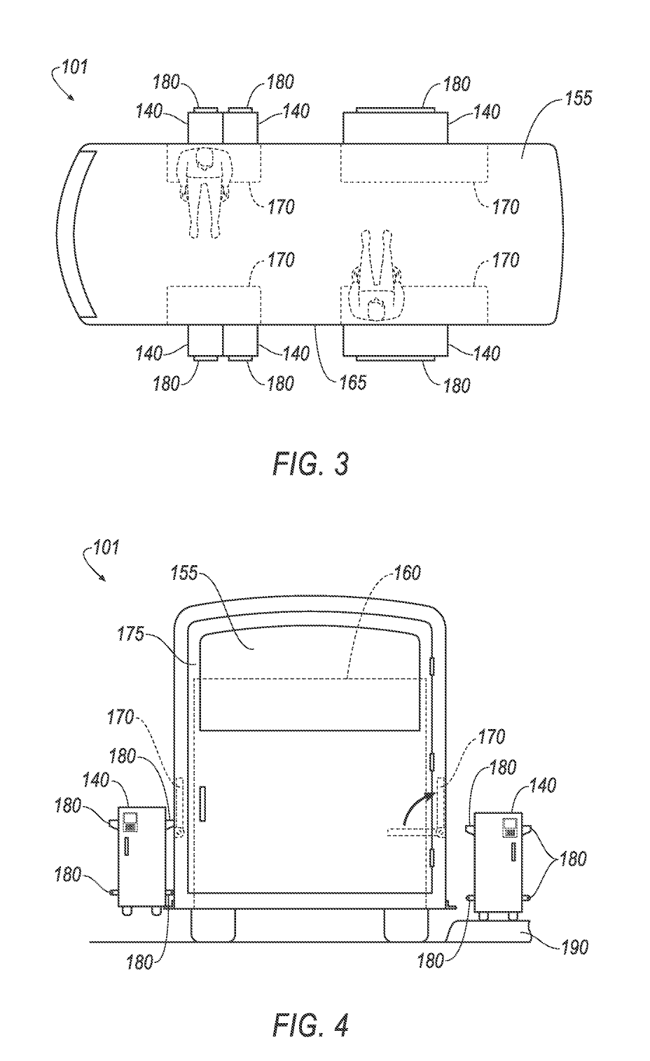

The carrier 101 may include a plurality of cargo containers 140. The cargo containers 140 store items of cargo 160. The cargo containers 140 may be attached to a side of the carrier 101, as described below. The cargo containers 140 may attach to the carrier 101 along a delivery route to reduce the energy consumed by the cargo containers 140 to deliver the cargo 160. FIGS. 2 and 5 show the cargo containers 140 storing packages of cargo 160 for delivery. As shown in FIGS. 3-4, the cargo containers 140 may attach to more than one side of the carrier 101. Furthermore, the cargo containers 140 may have more than one size, i.e., one of the cargo containers 140 may be larger than another one of the cargo containers 140. Thus, different sizes of cargo 160 may be transported by the cargo containers 140.

Each of the cargo containers 140 may include a plurality of securing apparatuses 180. The securing apparatuses 180 secure the cargo container 140 to the carrier 101. The securing apparatuses 180 may be, e.g., flanges, pins, etc. The carrier 101 includes a plurality of ports 185 arranged to receive the securing apparatuses 180. The ports 185 may be disposed on an exterior of the cab 155. The securing apparatuses 180 may include a movable element to securably engage the ports 185, e.g., the securing apparatuses 180 may include a movable latch (not shown.) that secures the securing apparatus 180 to the port 185. The container computing device 145 can actuate the securing apparatuses 180 to attach to the ports 185, securing the cargo container 140 to the carrier 101.

FIG. 3 illustrates a top view of the carrier 101. The carrier 101, includes a plurality of passenger benches 170. The passenger benches 170 may be attached to a side of the cab 155. The passenger benches 170 allow the passengers to sit while riding the carrier 101. As shown in FIG. 4, the passenger benches 170 may be folded from a deployed state, where passengers may sit on the passenger benches 170, to a stowed state, where the passenger benches 170 are moved toward the side of the cab 155 to allow an item of cargo 160 to be placed in the cab 155.

FIG. 4 illustrates a rear view of the carrier 101. Here, the carrier 101 includes an item of cargo 160 larger than the cargo containers 140, and thus the cargo 160 must be stored in the cab 155. A rear door 175 may open to allow access to the cab, and the passenger benches 170 may be folded to the stowed position to allow room for the cargo 160.

FIG. 4 further illustrates one of the containers 140 disengaging from the side of the carrier 101. As described below, the container 140 may attach to the carrier 101 to move along at least a portion of the delivery route. When the route of the carrier 101 leaves the route of the container 140, the container 140 may disengage from the carrier 101., e.g., at a stop along the route of the carrier 101. As shown in FIG. 4, the container computing device 145 can instruct the securing apparatuses 180 to detach from the ports 185, moving away from the carrier 101 and onto a curb 190. in addition, when the cargo container 140 is attached to the exterior of the cab 155 and is not adjacent the curb 190, the cargo container 140 may detach from the carrier 101 and move along a roadway to the curb 190, e.g., to a curb cut, a ramp, etc.

FIG. 5 illustrates an example cargo container 140. The cargo container 140 delivers cargo 160 from the cargo sender to the cargo recipient. The cargo container 140 includes a door 195 enclosing a chamber 200. The door 195 protects the cargo 160 and allows access to the chamber 200. The chamber 200 stores the cargo 160.

The cargo container 140 may include a lock 205. The lock 205 secures the door 195 to the sides of the cargo container 140. The lock 205 prevents users other than the cargo sender and the cargo recipient from accessing the cargo 160 stored in the chamber 200. The lock 205 may be, e.g., a combination lock, an electronic lock, etc.

The cargo container 140 may include an access panel 210. The access panel 210 allows the cargo recipient to input a code sent from the server 130 to release the lock 205 and access the cargo 160 in the chamber 200. As described above, the cargo recipient and the container computing device 115 receive the code assigned by the server 130. The container computing device 145 may receive inputs from the access panel 210 to determine whether the input matches the assigned code. If the input code matches the assigned code, the container computing device 145 releases the lock 205. The access panel 210 may be, e.g., a touchscreen, an alphanumeric keypad, etc.

The cargo container 140 may include one or more subsystems 150 that are anti-theft device 150. The anti-theft device 150 may be a subsystem 150 that prevents unauthorized access to the cargo 160 in the cargo container 140. The container computing device 145 may be programmed to actuate the anti-theft device 150 When the user inputs an incorrect code. The container computing device 145 may be further programmed to allow the user more than one attempt at inputting the code before actuating the anti-theft device 150. The anti-theft device 150 may be, e.g., a siren, a horn, etc. The anti-theft device 150 may send a notification to, e.g., a user device, a law enforcement officer, etc. The anti-theft device 150 may further capture an image of the user and upload the image to a secured server using known security protocols. The cargo container 140 may further include a battery (not shown) to power the subsystems 150, the lock 205, and the access panel 210.

FIG. 6 illustrates an example route 215 that the cargo container 140 travels. The server 130 may determine the route 215 from the location of the cargo container 140 to a pickup location 220 and to a delivery location 225. The pickup location 220 is the location of a cargo sender that will load the cargo 160 into the cargo container 140. The delivery location 225 is the location of a cargo recipient that will receive the cargo 160 from the cargo container 140. The route 215 may be divided into a pickup route 215a and a delivery route 215b. The pickup route 215a starts at the initial location of the cargo container 140 and ends at the pickup location 220. The delivery route 215b starts at the pickup location 220 and ends at the delivery location 225.

As described above, one or more carriers 101 may travel one or more predetermined carrier routes 230. The carrier routes 230 may include a plurality of carrier stops 235. The carrier 101 may collect passengers at the carrier stops 235. The carrier routes 230 may follow the route 215, allowing the cargo container 140 to attach to one of the carriers 101 to move along the route 215. The server 130 may determine a first carrier stop 235a that is closest to the cargo container 140 and a second carrier stop 235b that is closest to one of the pickup location 220 and the delivery location 225. That is, the second carrier stop 235b is where the carrier route 230 leaves the route 215. The cargo container 140 may attach to one of the carriers 101 at the first carrier stop 235a and detach from the carrier 101 at the second carrier stop 235b. Thus, the cargo container 140 may move along the route 215 while reducing energy consumption, and the carrier 101 can transport, passengers and the cargo container 140. The cargo container 140 may attach to more than one carrier 101 along the route 215.

For example, the server 130 may determine the pickup route 215a, including the first and second carrier stops 235a, 235b. The server 130 may send the pickup route 215a to the container computing device 145. The container computing device 145 may actuate the securing apparatuses 180 to attach to the carrier 101 at the first carrier stop 235a. The carrier 101 then moves the cargo container 140 along the carrier route 230 until reaching the second carrier stop 235b. The server 130 can identify more than one carrier route 230 between the location of the cargo container 140 and the pickup location 220 and identify a respective carrier 101 for each carrier route 230. The server 130 can identify a respective attachment location and detachment location for each carrier route. The attachment location indicates where the container 140 attaches to the carrier 101 on the carrier route 230, e.g., the first carrier stop 235a. The detachment location indicates where the cargo container 140 detaches from the carrier 101 on the carrier route 230, e.g., the second carrier stop 235b. The server 130 can instruct the container computing device 145 to control the container propulsion 150 to move the cargo container 140 from one of the detachment locations to one of the attachment locations to attach to another carrier 101. The container computing device 145 may actuate the securing apparatus 180 to detach from the carrier 101 and actuate container subsystems 150 to move to the pickup location 220. At the pickup location 220, the cargo sender places the cargo 160 in the chamber 200 and secures the lock 205.

The server 130 may then determine the delivery route 215b, including a third carrier stop 235c and a fourth carrier stop 235d, and send the delivery route 215b to the container computing device 145. The container computing device 145 may actuate the securing apparatuses 180 to attach to another carrier 101 at the third carrier stop 235c. The carrier 101 then moves along the carrier route 230 until reaching the fourth carrier stop 235d, where the container computing device 145 may actuate the securing apparatus 180 to detach from the carrier 101. The container computing device 145 may actuate container subsystems 150 to move the cargo container 140 to the delivery location 225. At the delivery location 225, the cargo recipient may input a code sent by the server to the cargo recipient and to the container computing device 145. If the code input by the cargo recipient matches the code sent by the server 130, then the container computing device 145 may disengage the lock 205 and allow the cargo recipient to open the door 195 and collect the cargo from the chamber 200. If the code input by the cargo recipient differs from the code sent by the server 130, the container computing device 145 may actuate one or more anti-theft devices 150.

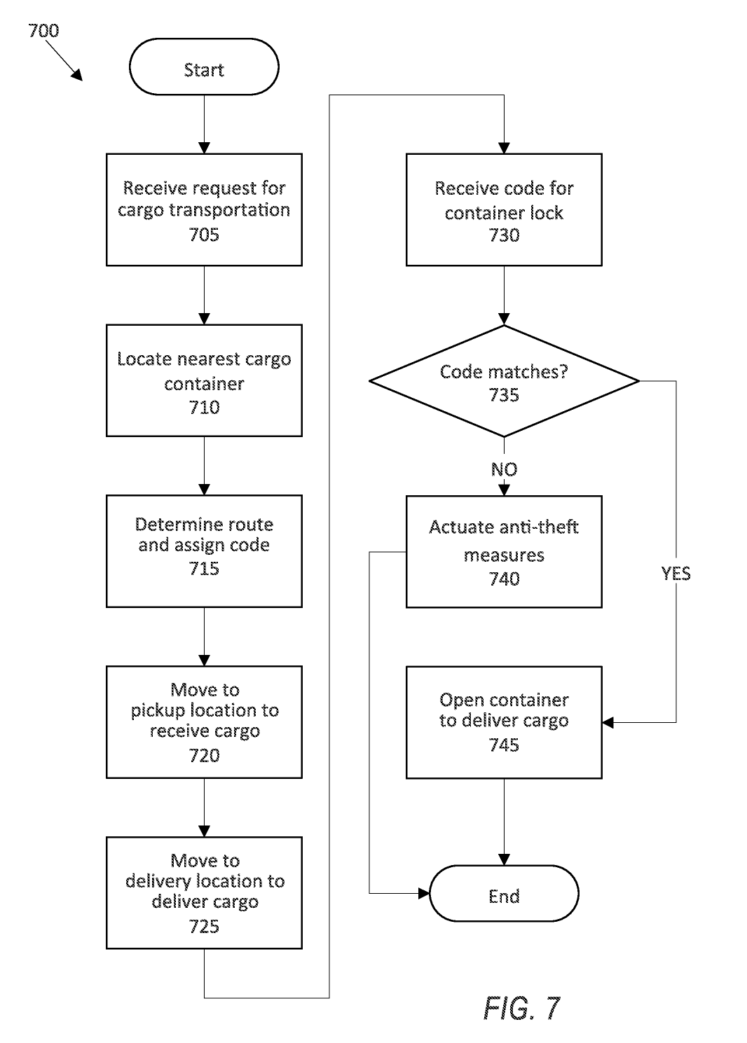

FIG. 7 illustrates an example process 700 for picking up and delivering items of cargo 160. The process 700 begins in a block 705, where the server 130 receives a request for transportation of cargo 160. As described above, the request includes the cargo 160 to be delivered, including a cargo size, a pickup location 220, and a delivery location 225. The request may further include a preferred time for the cargo container 140 to arrive at the pickup location 220 and/or the delivery location 225.

Next, in a block 710, the server 130 locates a cargo container 140 closest to the pickup location 220 that is sized to receive the cargo. The server 130 may compare location data 115 of a plurality of cargo containers 140 to the pickup location 220 and determine that the location data 115 of one of the cargo containers 140 is closest to the pickup location 220.

Next, in a block 715, the server 130 determines a route 215 from the location of the cargo container 140 to the delivery location 225 and assigns a code identifying the cargo recipient. The route 215 may include a pickup route 215a from the location of the cargo container 140 to the pickup location 220 and a delivery route 215b from the pickup location 220 to the delivery location 225. Alternatively, the server 130 can determine the pickup route 215a upon identifying the cargo container 140 and determine the delivery route 215b when the cargo container 140 reaches the pickup location 220. The server 130 can identify locations along the route 215 where the container 140 can attach to a carrier 101, e.g., carrier stops 235. The server 130 can assign a code and send the code to a cargo recipient and to the container computing device 145. The cargo recipient can input the code with the access panel 210 to unlock the lock 205 and receive the cargo 160.

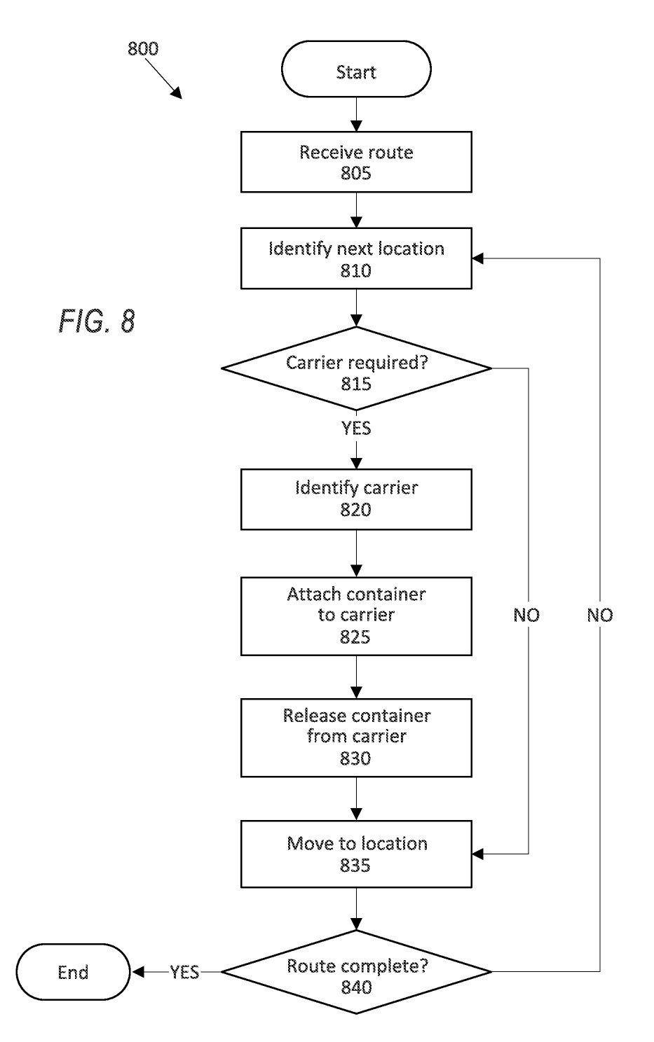

Next, in a block 720, the server 130 instructs the cargo container 140 to actuate cargo container components 150 to move to the pickup location 220 to receive the cargo 160. Upon arriving at the pickup location 220, the cargo sender places the package in the chamber 200 and actuates the lock 205. As described below and shown in FIG. 8, the cargo container 140 may attach to one or more carriers 101 to move along the pickup route 215a to the pickup location 220

Next, in a block 725, the server 130 instructs the cargo container 140 to move to the delivery location 225 to deliver the cargo 160. As described below, the cargo container 140 may attach to one or more carriers 101 to move along the delivery route 215b from the pickup location 220 to the delivery location 225.

Next, in a block 730, the cargo container 140 receives an input from the access panel 210 from the cargo recipient to unlock the cargo container 140 and deliver the cargo 160. As described above, the input can be an alphanumeric code assigned by the server 130 and previously sent to the container computing device 145 and to the cargo recipient.

Next, in a block 735, the container computing device 145 determines whether the input code matches the assigned code received from the server 130, as described above. If the input code from the cargo recipient matches the code assigned by the server 130, the process 700 continues in a block 745. Otherwise, the process 700 continues in a block 740. The container computing device 145 may allow the cargo recipient to submit more than one input code before proceeding to the block 740 to allow the cargo recipient to correct a mistaken input code.

In the block 740, the container computing device 145 actuates the anti-theft device 150, as described above, and the process 700 ends. For example, the container computing device 145 may actuate a siren, send a notification to the cargo sender, etc.

In the block 745, the container computing device 145 releases the lock 205, and the process 700 ends. Releasing the lock 205 allows the cargo recipient to open the door 195 and collect the cargo 160, e.g., the package.

FIG. 8 illustrates a process 800 for moving the cargo container 140 along the route 215. Alternatively, the process 800 may be used to move the cargo container 140 along one of the pickup route 215a and the delivery route 215b. The process 800 starts in a block 805, where the container computing device 145 receives the route 215 from the server 130, including the pickup location 220, the delivery location 225, and the carrier stops 235 where the cargo container 140 can attach to one of the carriers 101.

Next, in a block 810, the container computing device 145 identifies the next location in the route 215 to which the cargo container 140 must travel. The location may be, e.g., the pickup location 220. the delivery location 225, etc. For example, if the cargo container 110 is at the pickup location 220, the container computing device 145 may determine that the next location is the delivery location 225. In another example, the server 130 can identify a carrier stop 235 between the initial location of the cargo container 140 and the pickup location 220, At the carrier stop 235 identified by the server 130, the cargo container 140 detaches from a first carrier 101 and attaches to a second carrier 101. The container computing device 145 can identify the carrier stop 235 identified by the server 130 as the next location. That is, the next location in the route 215 can be defined by the container computing device 145 as the subsequent location on the route 215 that requires at most one carrier 101 to reach.

Next, in a block 815, the container computing device 145 determines whether the cargo container 140 will require one of the carriers 101 to reach the next location. For example, if one of the carrier routes 230 follows the route 215 between the current location of the cargo container 140 and the next location, the container computing device 145 may determine that one of the carriers 101 is required to move to the next location. Alternatively, the server 130 may compare the route 215 to the carrier routes 230 and instruct the container computing device 145 that one of the carriers 101 is required to move to the next location. In another example, the next location may be closer than the nearest carrier stop 235, and the container computing device 145 can determine that one of the carriers 101 is not required. If the container computing device 145 determines that the cargo container 140 requires one of the carriers 101 to reach the next location on the route 215, the process 800 continues in a block 820. Otherwise, the process 800 continues in a block 835.

In the block 820, the container computing device 145 identifies the carrier 101 that can move the cargo container 140 to the next location. The container computing device 145 may identify the carrier 101 based on data 115 from the server 130 regarding the carrier routes 230 and schedules. That is, upon determining the carrier route 230 that allows the cargo container 140 to move toward the next location, the container computing device 145 may compare an estimated time of arrival of the carriers 101 that travel along the carrier route 230 to an estimated time of arrival of the cargo container 140 at one of the carrier stops 235 and identify a specific carrier 101 that may transport the cargo container 140.

Next, in a block 825, the container computing device 145 moves to the carrier stop 235 and actuates the securing apparatuses 180 to attach to the ports 185 on the side of the carrier 101. As described above, the container computing device 145 may actuate the securing apparatuses 180 to move with the carrier 101 along the carrier route 230, reducing the energy consumption of the cargo container 140. For example, as shown. in FIG. 6, the cargo container 140 may attach to the carrier 101 at the first carrier stop 235a.

Next, in a block 830, the container computing device 145 releases the securing apparatuses 180 from the ports 185 upon determining that the carrier 101 has reached the carrier stop 235 where the route 215 of the cargo container 140 diverges from the carrier route 230. For example, as described above and shown in FIG. 6, the cargo container 140 may detach from the carrier 101 at the second carrier stop 235b.

In the block 835, the container computing device 145 actuates the container subsystems 150 to move to the location. For example, the container computing device 145 can actuate a container propulsion, brake, etc.

Next, in a block 840, the container computing device 145 determines whether the cargo container 140 has completed the route 215 upon arriving at the location. For example, upon reaching the pickup location 220, the container computing device 145 may determine that the route 215 has not completed, i.e., the cargo container 140 still has to go to the delivery location 225. In another example, the cargo container may complete the route 215 upon reaching the delivery location 225. If one or more locations remain in the route 215, the process 800 returns to the block 810 to identify the next location. Otherwise, the process 800 ends.

As used herein, the adverb “substantially” modifying an adjective means that a shape, structure, measurement, value, calculation, etc. may deviate from an exact described geometry, distance, measurement, value, calculation, etc., because of imperfections in materials, machining, manufacturing, data collector measurements, computations, processing time, communications time, etc.

Computing devices 105, 145 generally each include instructions executable by one or more computing devices such as those identified above, and for carrying out blocks or steps of processes described above. Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in the computing device 105 is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 800, one or more of the steps could be omitted, or the steps could be executed in a different order than shown in FIG. 8. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

1. A system, comprising:
a server, including a processor and a memory; and
a plurality of cargo containers, each cargo container including a processor, a memory, wheels, and a propulsion connected to the wheels;
wherein the memory of the server stores instructions executable by the processor of the server to:
receive a request to deliver cargo, the request including a pickup location and a delivery location;
identify one of the cargo containers to deliver the cargo;
determine a delivery route from a location of the cargo container to the pickup location and from the pickup location to the delivery location based at least in part on a carrier route; and
instruct the processor of the cargo container to control the propulsion to move the cargo container along the delivery route to the delivery location. The system of claim 1, wherein the instructions further include instructions to identify a first location where the cargo container follows the carrier route, to identify a carrier arriving at the first location, and to instruct the processor of the cargo container to control the cargo container to attach the cargo container to the carrier when the carrier reaches the first location.

3. The system of claim 2, wherein the instructions further include instructions to identify a second location where the cargo container leaves the carrier route and to instruct the processor of the cargo container to control the cargo container to detach the cargo container from the carrier when the carrier reaches the second location.

4. The system of claim 3, wherein the instructions further include instructions to instruct the processor of the cargo container to control the cargo container to move the cargo container from the second location to the pickup location.

5. The system of claim 4, wherein the instructions further include instructions to identify a third location at which the cargo container follows a second carrier route, to identify a second carrier arriving at the third location, and to instruct the processor of the cargo container to control the cargo container to attach the cargo container to the second carrier when the second carrier reaches the third location.

6. The system of claim 5, wherein the instructions further include instructions to identify a fourth location at which the cargo container leaves the second carrier route and to instruct the processor of the cargo container to control at least one container subsystem to detach the cargo container from the second carrier when the second carrier reaches the fourth location and to control the propulsion to move the cargo container from the fourth location to the delivery location.

7. The system of claim 1, wherein the instructions further include instructions to select the cargo container that is a shortest distance from the pickup location.

8. The system of claim 1, wherein the cargo container includes a lock, wherein the instructions further include instructions to:
assign a code identifying a cargo recipient to disengage the lock;
send the code to the cargo container and to the cargo recipient;
receive an input from the cargo recipient; and
disengage the lock when the input is the same as the code and actuate an anti-theft device in the cargo container when the input differs from the code.

9. The system of claim 1, wherein the instructions further include instructions to collect a passenger in the carrier at a first location where the carrier route meets the delivery route.

10. The system of claim 1, wherein the instructions further include instructions to identify more than one carrier route between the location of the cargo container and the pickup location and to identify a respective carrier for each carrier route, wherein each carrier route meets the delivery route at a respective attachment location and diverges from the delivery route at a respective detachment location.

11. The system of claim 10, wherein the instructions further include instructions to instruct the processor of the cargo container to control the propulsion to move the cargo container from one of the detachment locations to one of the attachment locations.

12. A system, comprising a computer including a processor and a memory, the memory storing instructions executable by the computer to:
receive a delivery route to a pickup location to collect cargo and to a delivery location to deliver the cargo, including a first location where a carrier route meets the delivery route and a second location where the carrier route diverges from the delivery route;
identify a carrier approaching the first location;
actuate a securing apparatus to engage a port disposed on the carrier when the carrier reaches the first location;
disengage the securing apparatus from the port when the carrier reaches the second location; and
control a propulsion to move a cargo container to the pickup location.

13. The system of claim 12, wherein the delivery route includes a third location where a second carrier route meets the delivery route and a fourth location where the second carrier route diverges from the delivery route.

14. The system of claim 13, wherein the instructions further include instructions to:
identify a second carrier approaching the third location;
actuate a securing apparatus to engage a second port disposed on the second carrier when the second carrier reaches the third location;
disengage the securing apparatus from the second port when the second carrier reaches the fourth location; and
control the propulsion to move the cargo container to the delivery location.

15. The system of claim 12, wherein the instructions further include instructions to receive an assigned code identifying a cargo recipient, to receive an input from an access panel, and to disengage a lock when the input matches the assigned code.

16. The system of claim 15, wherein the instructions further include instructions to actuate a siren when the input differs from the assigned code.

17. The system of claim 12, wherein the instructions further include instructions to identify more than one carrier route between a location of the cargo container and the pickup location and to identify a respective carrier for each carrier route, wherein each carrier route meets the delivery route at a respective attachment location and diverges from the delivery route at a respective detachment location.

18. The system of claim 17, wherein the instructions further include instructions to control the propulsion to move the cargo container from one of the detachment locations to one of the attachment locations.

19. A system, comprising a computer including a processor and a memory, the memory storing instructions executable by the computer to:
receive a request to receive cargo from a pickup location;
determine a delivery route from a location of a cargo container to the pickup location;
identify a carrier route along at least a portion of the delivery route, including a first location where the carrier route meets the delivery route and a second location where the carrier route diverges from the delivery route; and
instruct a processor of the cargo container to:
control the cargo container to attach the cargo container to the carrier;
control one or more container subsystems to detach the cargo container from the carrier upon arriving at the second location; and
control a container propulsion to move the cargo container from the second location to the pickup location.

20. The system of claim 19, wherein the instructions further include instructions to receive a plurality of requests to receive cargo, identify a respective cargo container for each request, determine a plurality of delivery routes, identify a carrier route along at least a portion of at least some of the delivery routes, and instruct the processor of the cargo container to control the container subsystems to attach the cargo containers assigned to the at least some of the delivery routes to a carrier traveling along the carrier route.
